(19) United States
(12) Patent Application Publication
(10) Pub. No.: US 2012/0019620 A1
(43) Pub. Date: Jan. 26, 2012

(54) IMAGE CAPTURE DEVICE AND CONTROL METHOD

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/026,275

(22) Filed: Feb. 13, 2011

(30) Foreign Application Priority Data
Jul. 20, 2010 (TW) 99123733

(51) Int. Cl. H04N 13/02

(52) U.S. Cl. 348/46; 348/E13.074

(57) ABSTRACT

An image capture device and method creates a first matrix for an image. A pixel value of each point in the first matrix is compared with a pixel value of a corresponding point in a 3D figure template, to detect a three-dimensional (3D) area in the image. A lens of the image capture device is moved and a foci of the lens is adjusted to ensure that the device capture a clear 3D figure image. A second matrix for the clear 3D figure image is created, and a pixel value of each point in the second matrix is compared with a pixel value of a corresponding point in a 3D facial template, to detect a 3D facial area in the clear 3D figure image. The lens is moved and the foci of the lens is adjusted to ensure that the device captures a clear 3D facial image.

### BACKGROUND

1. Technical Field

Embodiments of the present disclosure relates to surveillance systems, and more particularly, to an image capture device and a method of controlling the image capture device.

2. Description of Related Art

Video cameras with pan/tilt/zoom (PTZ) functions have been popularly adopted in surveillance systems. A PTZ video camera is able to focus on a target region at a distance with a wide angle range and capture an amplified image of the target region. The PTZ camera can be remotely controlled to track and record any activity in the region. However, real time observation of monitor displays is required to detect anomalous activity. If PTZ functions are not implemented in a timely manner, captured images may not be clear and recognizable.

### BRIEF DESCRIPTION OF THE DRAWINGS

FIG. 1 is a block diagram of one embodiment of an image capture device.

FIG. 2 is a block diagram of one embodiment of function modules of a control unit and a storage device in the image capture device of FIG. 1.

FIG. 3A and FIG. 3B are flowcharts of one embodiment of a method of controlling an image capture device.

FIG. 4 and FIG. 5 show examples of capture of three-dimensional (3D) images using the image capture device of FIG. 1.

FIG. 6 shows an example of capture of a 3D facial image using the image capture device of FIG. 1.

FIG. 7 shows an example of a scenic image.

FIG. 8 shows an example of a clear 3D figure image.

FIG. 9 shows an example of a clear 3D facial image.

### DETAILED DESCRIPTION

The disclosure, including the accompanying drawings in which like references indicate similar elements, is illustrated by way of examples and not by way of limitation. It should be noted that references to “an” or “one” embodiment in this disclosure are not necessarily to the same embodiment, and such references mean at least one.

In general, the word “module,” as used hereinafter, refers to logic embodied in hardware or firmware, or to a collection of software instructions, written in a programming language, such as, for example, Java, C, or Assembly. One or more software instructions in the modules may be embedded in firmware. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

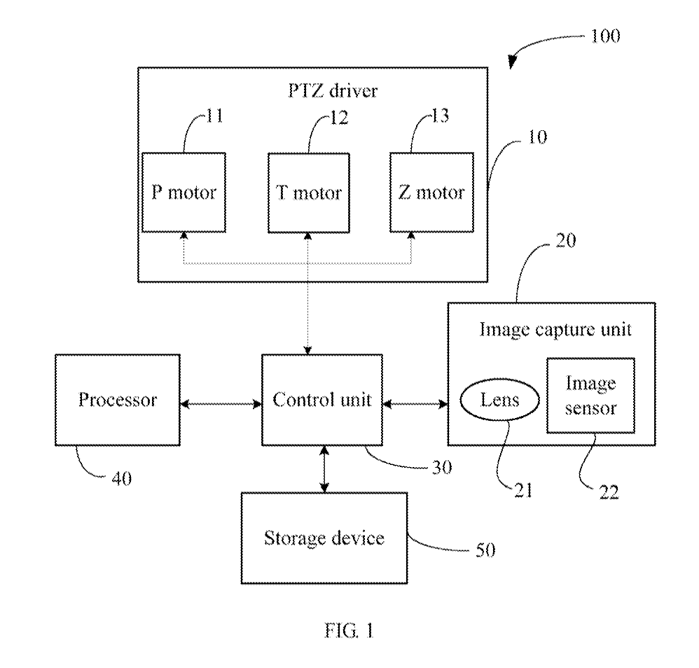

FIG. 1 is a block diagram of one embodiment of an image capture device 100. In one embodiment, the image capture device 100 includes a pan/tilt/zoom (PTZ) driver 10, an image capture unit 20, a control unit 30, a processor 40, and a storage device 50. The image capture unit 20 includes an image sensor 21 and a lens 22. It is understood that, in this embodiment, the image capture device 100 is a camera system that captures how far an object is from the lens 22 (“distant information”) with help of the time-of-flight (TOF) principle, which can obtain a distance between the lens 22 and each point on an object to be captured, so that each image captured by the capturing device 100 includes the distance information between the lens 22 and each point on the object in the image. The PTZ driver 10 includes a pan (P) motor 11, a tilt (T) motor 12, and a zoom (Z) motor 13 for driving x-axis movement, y-axis movement of the lens 22, and adjusting a foci of the lens 22 respectively. The image sensor 21 captures images of a target region via the lens 22. Depending on the embodiment, the storage device 50 may be a smart media card, a secure digital card, or a compact flash card.

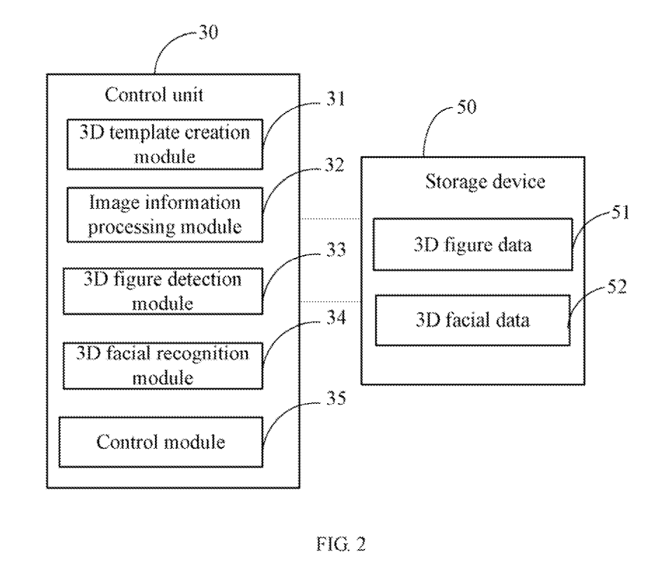

In one embodiment, the control unit 30 includes a number of function modules (depicted in FIG. 2). The function modules may comprise computerized code in the form of one or more programs that are stored in the storage device 50. The computerized code includes instructions that are executed by the processor 40, to compare a scene image with pre-stored three-dimensional (3D) images, and determine if the scene image includes 3D figure information, which is defined as an object that includes character points that can be used to construct an outline of a person. If the scene image includes 3D figure information, the control unit 30 directs the PTZ driver 10 to control x-axis movement, y-axis movement of the lens 22, and a foci of the lens 22, to capture a 3D figure image. Furthermore, the control unit 30 compares the 3D figure image with pre-stored 3D facial images based on distance information in the 3D figure image and the 3D facial images, to determine if the 3D figure image includes 3D facial information. If the 3D figure image includes 3D facial information, the control unit 30 further directs the PTZ driver 10 to drive x-axis movement, y-axis movement of the lens 22, and adjusts the foci of the lens 22, to capture a 3D facial image.

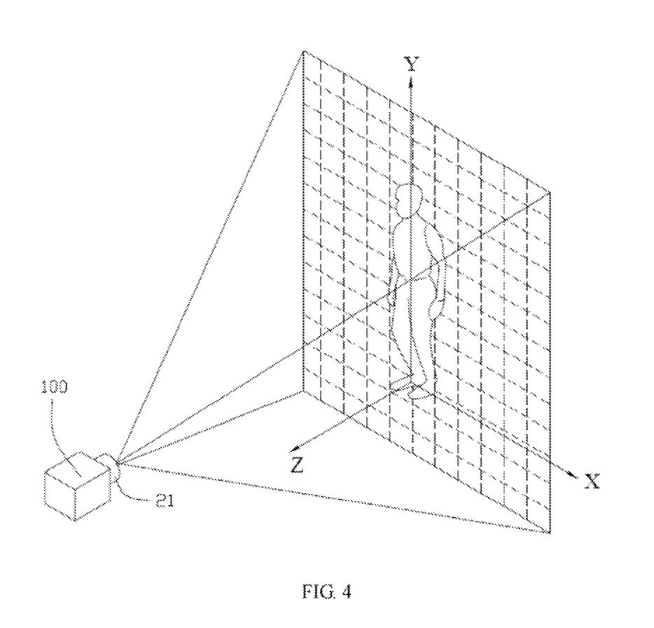

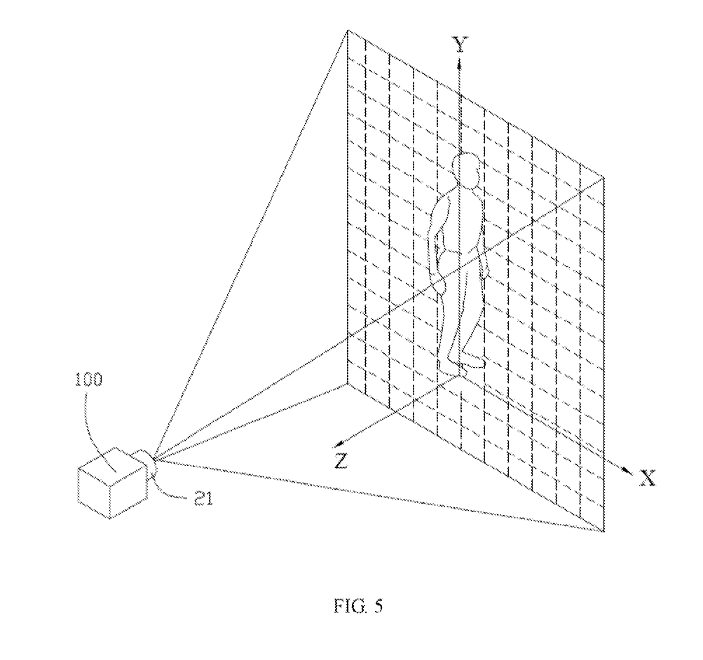

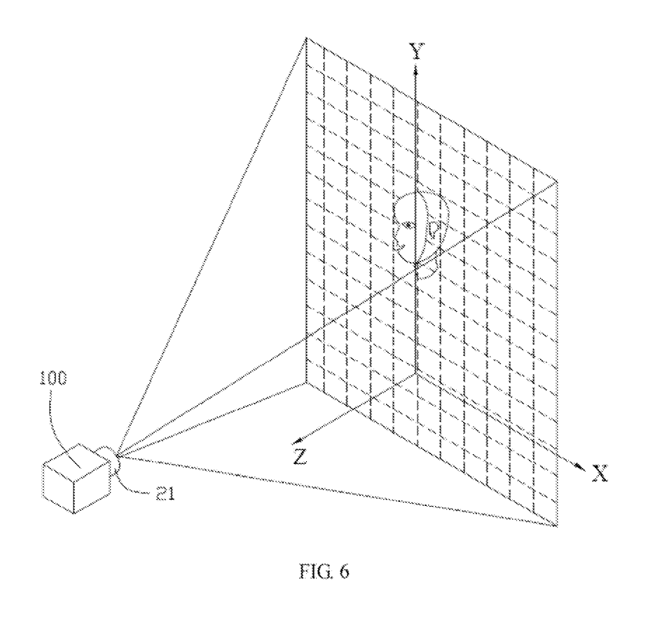

FIG. 2 is a block diagram of one embodiment of function modules of the control unit 30 and the storage device 50. The storage device 50 stores 3D figure data 51 and 3D facial data 52. The 3D figure data 51 includes the 3D figure images captured by the image capture device 100. In one embodiment, the 3D figure images may include frontal images (as shown in FIG. 4) and side images (as shown in FIG. 5), for example. It is understood that, a frontal image of a person is an image captured when the image capture device 100 is positioned in front of the person, and a side image of the person is an image captured when the image capture device 100 is positioned at one side of the person. The 3D facial data 52 includes 3D facial images (as shown in FIG. 6). The control unit 30 includes a 3D template creation module 31, an image information processing module 32, a 3D figure detection module 33, a 3D facial recognition module 34, and a control module 35.

The 3D template creation module 31 creates a 3D figure template for storing an allowable range for a pixel value of the same character point according to the distance information in the 3D figure images. For example, the 3D template creation module 31 reads a 3D figure image N1 shown in FIG. 5, obtains a distance between the lens 22 and each character point of the subject of the 3D figure image N1. In this embodiment, character points (such as the nose, the eyes) are points that can be used to construct an outline of a person. For example, a distance between the lens 22 and the nose may be 61 cm, a distance between the lens 22 and the forehead may be 59 cm.

The 3D template creation module 31 further converts each distance to a pixel value, for example, 61 cm may be converted to 255, and 59 cm may be converted to 253, and stores the pixel values of the character points into a character matrix of the 3D figure image. The character matrix is a data structure used for storing the pixel values of the character points in the 3D figure image. Furthermore, the 3D template creation module 31 aligns all character matrices of the 3D figure images based on a predetermined character point, such as a center of the figure in each 3D figure images, and records pixel values of the same character point in different character matrices into the 3D figure template. The pixel values of the same character point in different character matrices are regarded as the allowable range of the pixel value of the same character point. For example, an allowable range of the pixel value of the nose may be [251, 255], and an allowable range of the forehead may be [250, 254].

The 3D template creation module 31 further creates a 3D facial template for storing an allowable range for a pixel value of the same character point on faces according to the distance information in the 3D facial images. A creation process of the 3D facial template is similar to the creation of the 3D figure template as described above.

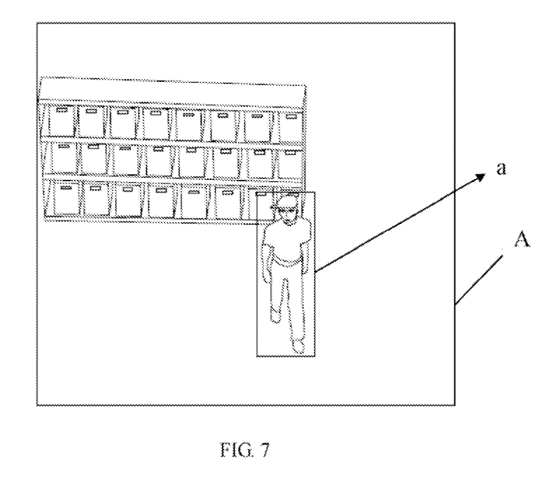

The image information processing module 32 reads a scene image of a target region (e.g., an image A in FIG. 7) captured by the image capture device 100, and converts a distance between the lens 22 and each point of the target region in the scene image to a pixel value of the point, to create a first character matrix of the scene image.

The 3D figure detection module 33 compares a pixel value of each point in the first character matrix with a pixel value of a corresponding character point in a 3D figure template, and determines if a first image area having a first number (e.g., n1) of points exists in the scene image, where a pixel value of each point in the first image area falls in an allowance range of a corresponding character point in the 3D figure template, to determine if the scene image includes a 3D figure area. For example, a pixel value of the nose in the first character matrix is compared with the pixel value of the nose in the 3D figure template. The 3D figure template may store a number Q1 of character points, and the first number may be set as Q1*80%. If the first image area exists in the scene image, the 3D figure detection module 33 determines that the first image area is a 3D figure area (e.g., the 3D figure area “a” in FIG. 7).

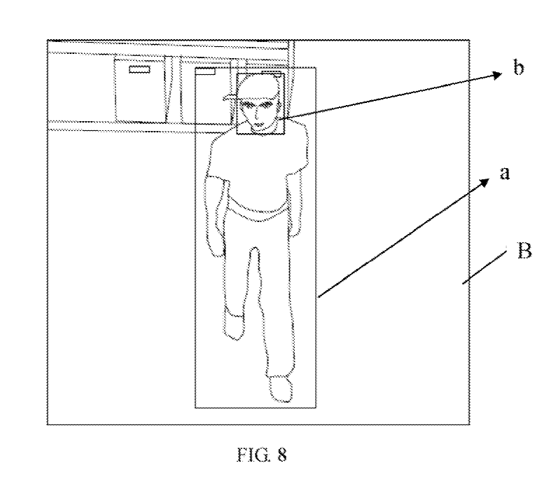

The control module 35 generates a first command according to a position of the 3D figure area in the scene image, and controls movement of the lens 22 according to the first command, to make a center of the 3D figure area superpose a center of the scene image. The control module 35 further generates a second command to adjust the foci of the lens 22, to make an area ratio of the 3D figure area to the scene image equal a first proportion (e.g., 45%). Based on the movement and the adjustment of the lens 22, the image capture device 100 captures a 3D figure image (e.g., an image B in FIG. 8), and stores the 3D figure image into the storage device 50. It is understood that, in this embodiment, if the area ratio of the 3D figure area to the scene image equals the first proportion, the scene image is regarded as the 3D figure image that is clear.

The image information processing module 32 further converts a distance between the lens 22 and each point of the subject of the 3D figure image to a pixel value of the point, to create a second character matrix of the 3D figure image.

The 3D facial recognition module 34 compares a pixel value of each point in the second character matrix with a pixel value of a corresponding character point in the 3D facial template, and determines if a second image area having a second number (e.g., n2) of points exists in the 3D figure image, where a pixel value of each point in the second image area falls in an allowance range of a corresponding character point in the 3D facial template, to determine if the 3D figure image includes a 3D facial area. If the second image area exists in the 3D figure image, the 3D facial recognition module 34 determines that the second image area is the 3D facial area (e.g., the area “b” in FIG. 8).

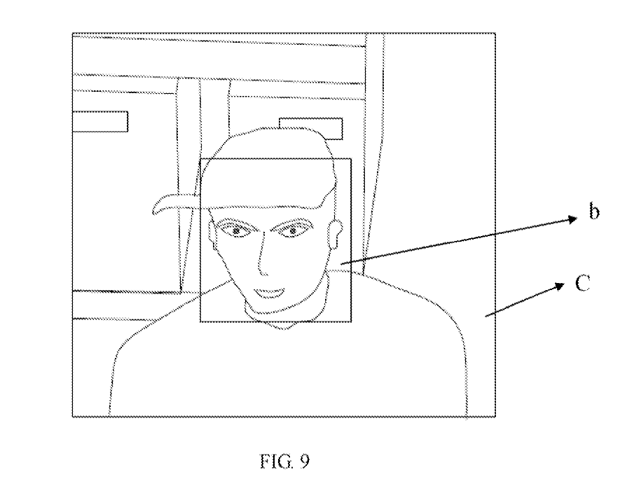

The control module 35 generates a third command according to a position of the 3D facial area in the 3D figure image, and controls movement of the lens 22 according to the third command, to make a center of the 3D facial area superpose a center of the 3D figure image. The control module 35 further generates a fourth command to adjust the foci of the lens 22, to make an area ratio of the 3D facial area to the 3D figure image equal a second proportion (e.g., 33%). Based on the movement and the adjustment of the lens 22, the image capture device 100 captures a 3D facial image (e.g., such as an image C in FIG. 9), and stores the 3D facial image into the storage device 50. It is understood that, in this embodiment, if the area ratio of the 3D facial area to the 3D figure image equals the second proportion, the 3D figure image is regarded as the 3D facial image that is clear.

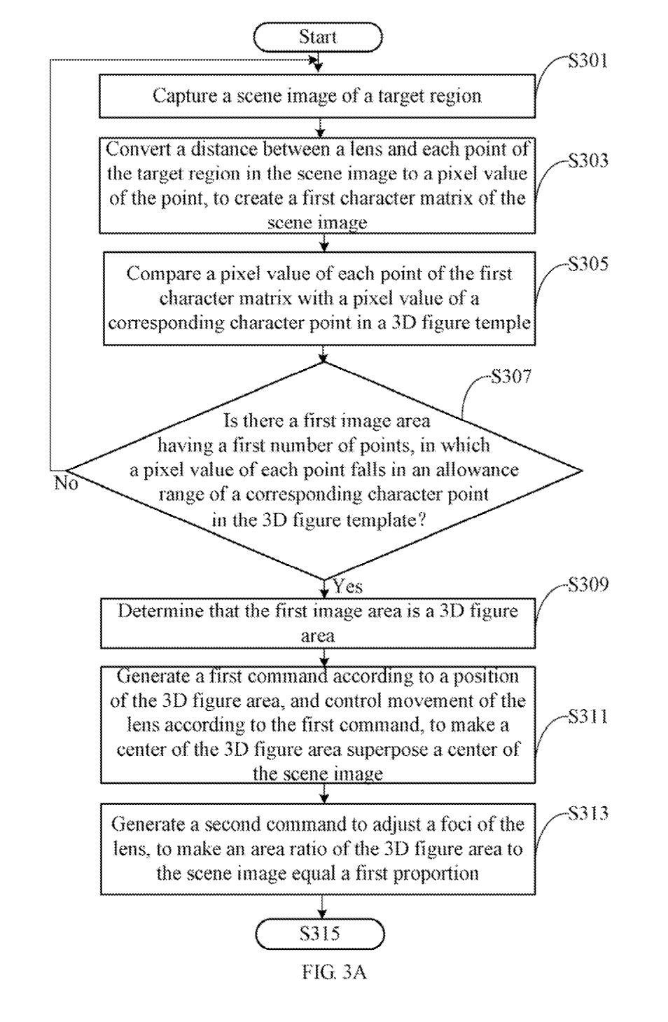

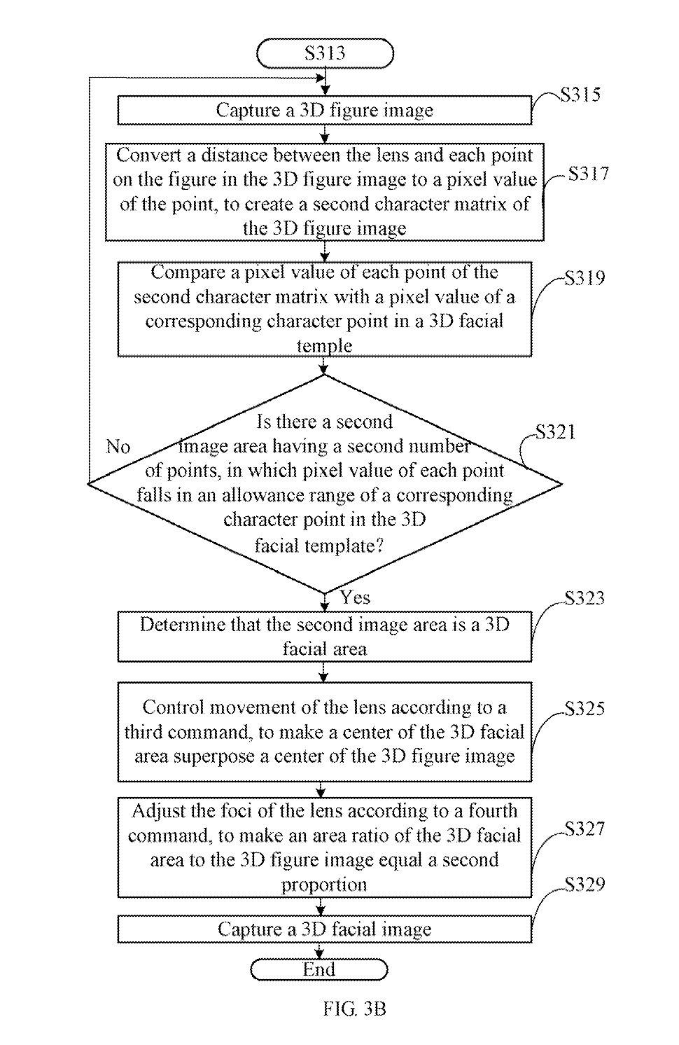

FIG. 3A and FIG. 3B show a flowchart of one embodiment of a method of controlling the image capture device 100. Depending on the embodiment, additional blocks may be added, others removed, and the ordering of the blocks may be changed.

In block S301, the image capture device 100 captures a scene image of a monitored area (e.g., an image A in FIG. 7).

In block S303, the image information processing module 32 converts a distance between the lens 22 and each point of the monitored area in the scene image to a pixel value of the point, to create a first character matrix of the scene image.

In block S305, the 3D figure detection module 33 compares a pixel value of each point in the first character matrix with a pixel value of a corresponding character point in a 3D figure template. For example, a pixel value of the nose in the first character matrix is compared with the pixel valued of the nose in the 3D person temple.

In block S307, the 3D figure detection module 33 determines if a first image area having a first number (e.g., n1) of points exists in the scene image, where a pixel value of each point in the first image area falls in an allowance range of a corresponding character point in the 3D figure template, to determine if the scene image includes a 3D figure area. For example, the 3D figure template may store a number Q1 of character points, and the first number may be set as Q1*80%. If the first image area does not exist in the scene image, the 3D figure detection module 33 determines that the scene image does not include subject information, such as no figure in the monitored area, and block S301 is repeated. If the first image area exists in the scene image, block S309 is implemented.

In block S309, the 3D figure detection module 33 determines that the first image area is a 3D figure area. For example, the image area “a” in the image A of FIG. 7 may be determined as the 3D figure area.

In block S311, the control module 35 generates a first command according to a position of the 3D figure area in the scene image, and moves the lens 22 according to the first command, to make a center of the 3D figure area superpose a center of the scene image.

In block S313, the control module 35 generates a second command to adjust the foci of the lens 22, to make an area ratio of the 3D figure area to the scene image equal a first proportion (e.g., 45%).

Based on the movement and the adjustment of the lens 22, in block S315, the image capture device 100 captures a 3D figure image (e.g., an image B in FIG. 8), and stores the 3D figure image into the storage device 50.

In block S317, the image information processing module 32 converts a distance between the lens 22 and each point of the subject of the 3D figure image to a pixel value of the point, to create a second character matrix of the 3D figure image.

In block S319, the 3D facial recognition module 34 compares a pixel value of each point in the second character matrix with a pixel value of a corresponding character point in the 3D facial template. For example, a pixel value of the nose in the second character matrix is compared with the pixel valued of the nose in the 3D face temple.

In block S321, the 3D facial recognition module 34 determines if a second image area having a second number (e.g., n2) of points exists in the 3D figure image, where a pixel value of each point in the second image area falls in an allowance range of a corresponding character point in the 3D facial template, to determine if the 3D figure image includes a 3D facial area. If the second image area does not exist in the 3D figure image, the 3D facial recognition module 34 determines that the 3D figure image does not include 3D facial information (e.g., the face of the person in the monitored area may be not in front of the lens 22), and block S315 is repeated, the image capture device 100 waits for the subject of the monitored area to turn round and captures a next 3D figure image. If the second image area exists in the 3D figure image, block S323 is repeated.

In block S323, the 3D facial recognition module 34 determines the second image area as the 3D facial area. For example, the image area “b” in the image B of FIG. 8 is determined as the 3D facial area.

In block S325, the control module 35 generates a third control command according to a position of the 3D facial area in the 3D figure image, and moves the lens 22 according to the third command, to make a center of the 3D facial area superpose a center of the 3D figure image.

In block S327, the control module 35 generates a fourth command to adjust the foci of the lens 22, to make an area ratio of the 3D facial area to the 3D figure image equal a second proportion (e.g., 33%).

In block S329, based on the movement and the adjustment of the lens 22, the image capture device 100 captures a 3D facial image (e.g., an image C in FIG. 9), and stores the 3D facial image into the storage device 50.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method of controlling an image capture device, the method comprising:
reading a scene image of a monitored area captured by the image capture device, and creating a first character matrix of the scene image by converting a distance between a lens of the image capture device and each point of the monitored area in the scene image to a pixel value of the point;
comparing a pixel value of each point in the first character matrix with a pixel value of a corresponding character point in a three-dimensional (3D) person template, to detect a first image area having a first number of points in the scene image as a 3D figure area, wherein a pixel value of each point in the first image area falls in an allowance range of a corresponding character point in the 3D figure template;
controlling movement of the lens according to a first command to make a center of the 3D figure area superpose a center of the scene image, and adjusting a foci of the lens to make an area ratio of the 3D figure area to the scene image equal a first proportion according to a second command, so that the image capture device captures a 3D figure image;
converting a distance between the lens and each point of the subject of the 3D figure image to a pixel value of the point, to create a second character matrix of the 3D figure image;
comparing a pixel value of each point in the second character matrix with a pixel value of a corresponding character point in a 3D facial template, to detect a second image area having a second number of points in the 3D figure image as a 3D facial area, wherein a pixel value of each point in the second image area falls in an allowance range of a corresponding character point in the 3D facial template;
controlling movement of the lens according to a third command to make a center of the 3D facial area superpose a center of the 3D figure image, and adjusting the foci of the lens to make an area ratio of the 3D facial area to the 3D figure image equal a second proportion according to a fourth command, so that the image capture device captures a 3D facial image.

2. The method as claimed in claim 1, wherein the image capture device is a camera system that creates distant data using a time-of-flight principle, which obtains a distance between the lens and each point on an object to be captured.

3. The method as claimed in claim 1, wherein the 3D figure template stores an allowable range for a pixel value of the same character point according to distance information in 3D figure images pre-captured by the image capture device.

4. The method as claimed in claim 1, wherein the 3D facial template stores an allowable range for a pixel value of the same character point on faces according to distance information in 3D facial images pre-captured by the image capture device.

5. The method as claimed in claim 1, wherein the first control command is generated according to a position of the 3D figure area in the scenic image, and the third control command is generated according to a position of the 3D facial area in the 3D figure image.

6. The method as claimed in claim 3, wherein creation of the 3D figure template comprises:
reading a distance between the lens and each character point of a subject of a pre-captured 3D figure image;
converting each distance to a pixel value, and storing the pixel values of the character points into a character matrix of the pre-captured 3D figure image; and
aligning all character matrices of the pre-captured 3D figure images based on a predetermined character point, and recording pixel values of the same character point in different character matrices as the allowable range of the pixel value of the same character point.

7. An image capture device, comprising:
a storage device;
a lens;
at least one processor; and
a control unit comprising one or more computerized programs, which are stored in the storage device and executable by the at least one processor, the one or more computerized programs comprising:
an image information processing module operable to read a scene image of a monitored area captured by the image capture device, and convert a distance between a lens of the image capture device and each point of the monitored area in the scene image to a pixel value of the point, to create a first character matrix of the scene image;
a three-dimensional (3D) person detection module operable to compare a pixel value of each point in the first character matrix with a pixel value of a corresponding character point in a 3D figure template, to detect a first image area having a first number of points in the scene image as a 3D figure area, wherein a pixel value of each point in the first image area falls in an allowance range of a corresponding character point in the 3D figure template;
a control module operable to control movement of the lens according to a first command to make a center of the 3D figure area superpose a center of the scene image, and adjust a foci of the lens to make an area ratio of the 3D figure area to the scene image equal a first proportion according to a second command, so that the image capture device captures a 3D figure image;
the image information processing module further operable to convert a distance between the lens and each point of the subject of the 3D figure image to a pixel value of the point, to create a second character matrix of the 3D figure image;
a 3D facial recognition module operable to compare a pixel value of each point in the second character matrix with a pixel value of a corresponding character point in a 3D facial template, to detect a second image area having a second number of points in the 3D figure image as a 3D facial area, wherein pixel value of each point in the second image area falls in an allowance range of a corresponding character point in the 3D facial template; and
the control module further operable to control movement of the lens according to a third command to make a center of the 3D facial area superpose a center of the 3D figure image, and adjust the foci of the lens to make an area ratio of the 3D facial area to the 3D figure image equal a second proportion according to a fourth command, so that the image capture device captures a 3D facial image.

8. The image capture device as claimed in claim 7, wherein the image capture device is a camera system that creates distant data using a time-of-flight principle, which obtains a distance between the lens and each point on an object to be captured.

9. The image capture device as claimed in claim 7, wherein the 3D figure template stores an allowable range for a pixel value of the same character point according to distance information in 3D figure images pre-captured by the image capture device.

10. The image capture device as claimed in claim 7, wherein the 3D facial template stores an allowable range for a pixel value of the same character point on faces according to distance information in 3D facial images pre-captured by the image capture device.

11. The image capture device as claimed in claim 7, wherein the first control command is generated according to a position of the 3D figure area in the scene image, and the third control command is generated according to a position of the 3D facial area in the 3D figure image.

12. The image capture device as claimed in claim 9, wherein the control unit further comprises a 3D template creation module operable to:
read a distance between the lens and each character point of a subject of a pre-captured 3D figure image;
convert each distance to a pixel value and storing the pixel values of the character points into a character matrix of the pre-captured 3D figure image; and
align all character matrices of the pre-captured 3D figure images based on a predetermined character point, and record pixel values of the same character point in different character matrices as the allowable range of the pixel value of the same character point.

13. A non-transitory computer readable medium storing a set of instructions, the set of instructions capable of being executed by a processor of an image capture device to perform a method of controlling the image capture device, the method comprising:
reading a scene image of a monitored area captured by the image capture device, and converting a distance between a lens of the image capture device and each point of the monitored area in the scene image to a pixel value of the point, to create a first character matrix of the scene image;
comparing a pixel value of each point in the first character matrix with a pixel value of a corresponding character point in a three-dimensional (3D) person template, to detect a first image area having a first number of points in the scene image as a 3D figure area, wherein a pixel value of each point in the first image area falls in an allowance range of a corresponding character point in the 3D figure template;
controlling movement of the lens according to a first command to make a center of the 3D figure area superpose a center of the scene image, and adjusting a foci of the lens to make an area ratio of the 3D figure area to the scene image equal a first proportion according to a second command, so that the image capture device captures a 3D figure image;
converting a distance between the lens and each point of the subject of the 3D figure image to a pixel value of the point, to create a second character matrix of the 3D figure image;
comparing a pixel value of each point in the second character matrix with a pixel value of a corresponding character point in a 3D facial template, to detect a second image area having a second number of points in the 3D figure image as a 3D facial area, wherein a pixel value of each point in the second image area falls in an allowance range of a corresponding character point in the 3D facial template;
controlling movement of the lens according to a third command to make a center of the 3D facial area superpose a center of the 3D figure image, and adjusting the foci of the lens to make an area ratio of the 3D facial area to the 3D figure image equal a second proportion according to a fourth command, so that the image capture device captures a 3D facial image.

14. The medium as claimed in claim 13, wherein the image capture device is a camera system that creates distant data using a time-of-flight principle, which obtains distance information between the lens and each point on an object to be captured.

15. The medium as claimed in claim 13, wherein the 3D figure template stores an allowable range for a pixel value of the same character point according to distance information in 3D figure images pre-captured by the image capture device.

16. The medium as claimed in claim 13, wherein the 3D facial template stores an allowable range for a pixel value of the same character point on faces according to distance information in 3D facial images pre-captured by the image capture device.

17. The medium as claimed in claim 13, wherein the first control command is generated according to a position of the 3D figure area in the scenic image, and the third control command is generated according to a position of the 3D facial area in the 3D figure image.

18. The medium as claimed in claim 15, wherein creation of the 3D figure template comprises:
reading a distance between the lens and each character point of a subject of a pre-captured 3D figure image;
converting each distance to a pixel value and storing the pixel values of the character points into a character matrix of the pre-captured 3D figure image; and
aligning all character matrices of the pre-captured 3D figure images based on a predetermined character point, and records pixel values of the same character point in different character matrices as the allowable range of the pixel value of the same character point.

19. The medium as claimed in claim 13, wherein the medium a smart media card, a secure digital card, or a compact flash card.
